(19) United States
(12) Patent Application Publication
(10) Pub. No.: US 2015/0378560 A1
(43) Pub. Date: Dec. 31, 2015

(54) UNLOCKING CONTENT ON A COMPUTING DEVICE FROM A PREVIEW

(71) Applicant: Kobo Inc., Toronto (CA)

(72) Inventor: James Wu, Newmarket (CA)

(21) Appl. No.: 14/319,827

(22) Filed: Jun. 30, 2014

(51) Int. Cl. G06F 3/0484; G06F 3/0488; G06Q 20/12; G06F 3/0483

(52) U.S. Cl. CPC G06F 3/04842; G06F 3/0483; G06F 3/0488; G06Q 20/123

(57) ABSTRACT

One or more files corresponding to a content item are received. The received files include a locked portion and an unlocked portion. An application is executed to render the unlocked portion as a preview while the locked portion is locked. When the application is executing, a feature is provided for receiving a designated input that indicates the user accepts one or more conditions associated with the content item. In response to receiving the designated input, the locked portion of the content item is unlocked.

### TECHNICAL FIELD

Examples described herein relate to unlocking content on a computing device from a preview.

### BACKGROUND

An electronic personal display is a mobile electronic device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader, is an electronic personal display that is used for reading electronic books (eBooks), electronic magazines, and other digital content. For example, digital content of an eBook is displayed as alphanumeric characters and/or graphic images on a display of an e-reader such that a user may read the digital content much in the same way as reading the analog content of a printed page in a paper-based book. An e-reader provides a convenient format to store, transport, and view a large collection of digital content that would otherwise potentially take up a large volume of space in traditional paper format.

In some instances, e-readers are purpose built devices designed especially to perform especially well at displaying readable content. For example, a purpose built e-reader may include a display that reduces glare, performs well in high light conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for operating a computing device to render a content item from a preview, according to an embodiment.

FIG. 2 illustrates an example of an e-reader device or other electronic personal display device, for use with one or more embodiments described herein.

FIG. 3 illustrates an e-book device system for operating a computing device to render a content item from a preview, according to an embodiment.

FIG. 4 illustrates an example method for operating a network service to provide a content item with a preview segment.

FIG. 5 illustrates an example method for operating a computing device to render a preview segment of an e-book, and further to enable purchase of the e-book while the preview segment is rendered.

FIG. 6A and FIG. 6B illustrate an example in which an e-book is purchased while being previewed.

### DETAILED DESCRIPTION

Examples described herein enable computing devices, such as e-readers, to receive e-books that include preview segments. Prior to the user accepting to pay for the e-book, the user can view the preview segment. Once the user agrees to pay for the e-book, the e-book can be unlocked, or otherwise made renderable. Among other benefits, the unlocking mechanism can be local to the computing device, so that the e-book can be purchased even when the device is offline. Furthermore, the user can unlock the e-book while viewing the preview segment, thus maintaining a seamless reading experience.

According to one aspect, one or more files that correspond to a content item to a computing device, the one or more files including a locked portion and an unlocked portion, the unlocked portion being renderable to provide a preview of the content item on the computing device. One or more conditions for unlocking the locked portion of the one or more files are associated with the content item. A programmatic mechanism is provided to the computing device in order to enable a user of the computing device to provide input that accepts the one or more conditions and also unlocks the locked portion of the one or more files. The input provided by the user is detected, and the one or more conditions are implemented in response to detecting the input.

Another aspect provides for rendering content on a computing device. One or more files corresponding to a content item are received. The received files include a locked portion and an unlocked portion. An application is executed to render the unlocked portion as a preview while the locked portion is locked. When the application is executing, a feature is provided for receiving a designated input that indicates the user accepts one or more conditions associated with the content item. In response to receiving the designated input, the locked portion of the content item is unlocked.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

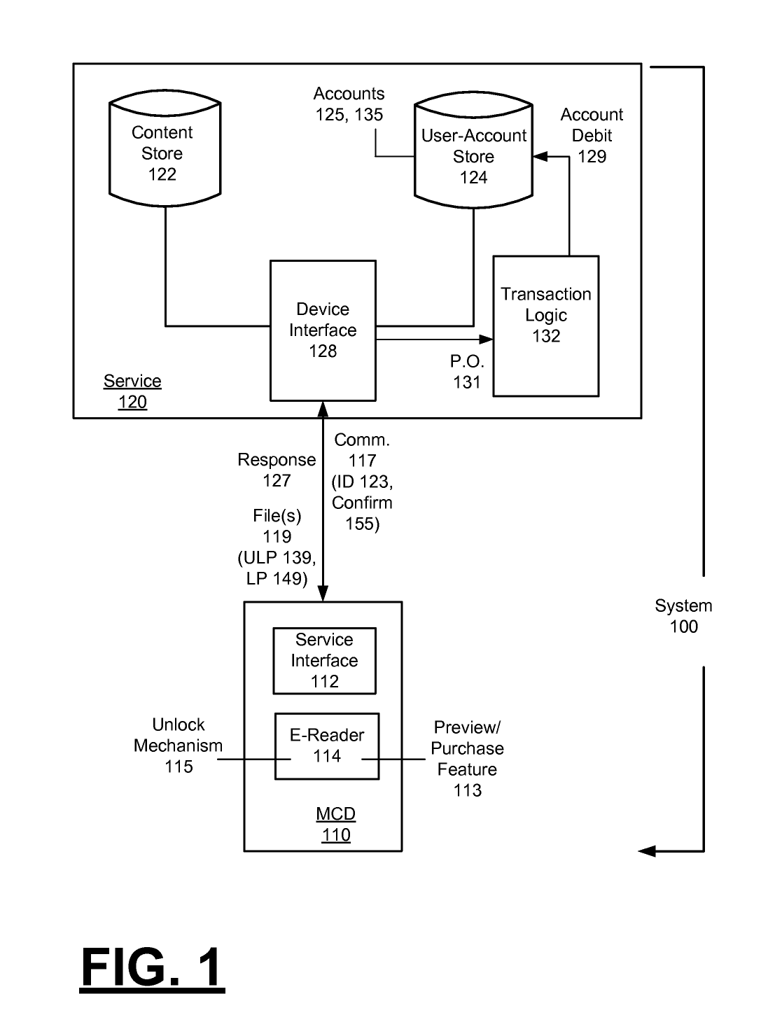

FIG. 1 illustrates a system for operating a computing device to render a content item from a preview, according to an embodiment. In an example of FIG. 1, system 100 includes an electronic display device, shown by way of example as an e-reader device 110, and a network service 120. While some examples described provide for an e-reader device which renders content items in the form of e-books and other text-based content, other implementations can utilize mobile computing devices that render other kinds of content items, such as portable or mobile computing devices for rendering music and video. Among other benefits, the e-reader device 110 can be operated by the user to render a preview of an e-book, and further to purchase or otherwise transact for the complete version of the e-book while maintaining a continuous application session that is initiated with the rendering of the preview segment. For example, in one application session, the user can view a preview segment of an e-book, purchase the e-book while viewing the e-book, and continue viewing pages from the e-book beyond the preview segment without interruption or discontinuity. In contrast to conventional approaches, an example of FIG. 1 provides that the user does not have to navigate away from the reading experience by performing actions such as opening a new window or application. Rather, the user can simply trigger an action to render the entire e-book while viewing the preview.

In an example of FIG. 1, the network service 120 can include multiple servers and other computing resources that provide various services in connection with one or more applications that are installed on the e-reader device 110. By way of example, in one implementation, the network service 120 can provide e-book services which communicate with the e-reader device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can run an e-reader application that links the device to the network service 120 and enables e-books provided through the service to be viewed and consumed. By way of example, the e-reader device 110 can be equipped with hardware and software to optimize certain application activities, such as rendering of electronic content (e.g., e-books). For example, the e-reader device 110 can have a tablet like form factor, although variations are possible. In some cases, the e-reader device 110 can also have an E-ink display.

In additional detail, the network service 120 can include a device interface 128, a resource store 122, a user account store 124 and transaction logic 132. The device interface 128 communicates with individual e-reader devices 110. In particular, the device interface 128 can communicate with individual e-reader devices in order to obtain the identifiers of the users (or user accounts) of such devices, and further to provide various services for downloading or enabling transactions for content items provided through network service 120. The user account store 124 can associate the e-reader device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account.

The transaction logic 132 can process transactions for the user of the e-reader device 110 in order to assist the user in obtaining or acquiring right of possession to content items provided through the network service 120. In one implementation, the transaction logic 132 executes to enable the user to purchase content items from the network service 120. The transaction logic 132 can implement a purchasing transaction, which can correspond to the account 125 of the user being (i) debited of funds, and (ii) associated with a content item (e.g., e-book, e-magazine, etc.) that the user has identified for purchase. The device interface 128 can deliver content items that the user has purchased to one or more e-reader devices associated with the account 125 of the user.

The e-reader device 110 can be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

With reference to FIG. 1, the e-reader device 110 includes a service interface 112 and an e-reader component 114. The service interface 112 and the e-reader component 114 can operate as part of a common application or application framework. For example, the service interface 112 and the e-reader component 114 can operate as an e-reader application that is provided through the network service 120. The service interface 112 can communicate with the network service 120 in order to receive services, content (e.g., e-books) account information and updates, and/or other network services (e.g., archiving). The e-reader component 114 can provide functionality for rendering e-books (including e-magazines or e-comic books) or other text-based content.

According to one aspect, the e-reader device can receive one or more files 119 for individual content items, such as e-books. The one or more files 119 can include metadata (e.g., title, author name, summary, jacket cover art etc.) and a content portion for an e-book. In one implementation, the e-reader device 110 is able to display a preview segment from content item such as e-books. According to some embodiments, network service 120 provides the content item for preview purposes in the form one or more files 119 which can include a preview segment and a complete version (or remainder) of the same content item. The preview segment can be rendered from an unlocked portion 139 of the one or more files 119, and the complete version of the content item can be provided by a locked portion 149 of the one or more files 119.

The e-reader component 114 also includes preview and purchasing functionality that utilizes the locked and unlocked structure of the one or more files 119. In one implementation, the service interface 112 receives the one or more files 119 from the network service 120, and the e-reader component 114 can render the unlocked portion 139 corresponding to the preview segment. At the same time, the e-reader component 114 can include a programmatic mechanism that precludes access to the locked portion of the one or more files 119. The e-reader component 114 can also be provided with a preview and purchase feature 113, which can be provided with the rendering of the unlocked portion 139 (preview segment). By way of example, the preview and purchase feature 113 can be displayed as an icon or other interactive feature that prompts the user for input. The input received through the preview and purchase feature 113 can be designated to indicate that the user accepts one or more conditions associated with being able to view the full content item (i.e., the locked portion 149 of the one or more files 119). The one or more conditions can correspond to payment terms (e.g., user agrees to pay funds from account 125 for full content provided by the one or more files 119).

The programmatic mechanism 115 can be triggered by input received through the preview and purchase feature 113. In one implementation, the programmatic mechanism 115 is directly responsive to such input, without any communication from the network service 120. In this way, the programmatic mechanism 115 can unlock the locked portion 149 of the one or more files 119 without receiving any further instructions or input from the network service 120. Thus, the programmatic mechanism 115 can operate to unlock the locked portion 149 of the one or more files 119 even when the e-reader device 110 is off-line, or otherwise operating without network connectivity or access to the network service 120.

When the user provides input via the preview and purchase feature 113, the e-reader device 110 signals a communication 117 to the network service 120. The communication 117 can signal the identifier of the e-reader device 110 (or user of that device), as well as a confirmation 155 that one or more conditions associated with unlocking the locked portion 149 of the one or more files 119 for the particular content item has been accepted by the user. As mentioned, the one or more conditions can correspond to payment terms. The service interface 112 can receive the communication 117, and signal a purchase order 131 to the transaction logic 132. The transaction logic 132 can debit 129 the users account based on the one or more conditions (e.g., payment terms). Further, the transaction logic 132 can associate the full content item with the user account 125. By way of example, the transaction logic 132 can associate a purchased e-book with the user account, so that the act of the user providing input to the preview and purchase feature 113 is equivalent to the user purchasing the e-book. This can be performed, for example concurrently or after the e-book is unlocked on the e-reader device 110. When the transaction is complete, the device interface 128 can signal a response 127 to the e-reader device 110 which confirms that the user has purchased the content item or otherwise complied with the one or more conditions. In the context of purchasing or other monetary transaction, the response 127 can indicate the amount that was debited from the user account.

On the e-reader device 110, the user can unlock the locked portion 149 of the one or more files 119 while rendering the preview segment of the same content item. The result can be that the user's experience in transitioning from rendering the preview segment to rendering the complete portion (e.g., pages of the book following the preview segment) is continuous and seamless upon the user accepting the one or more conditions associated with the particular content item (e.g., payment terms).

Hardware Description

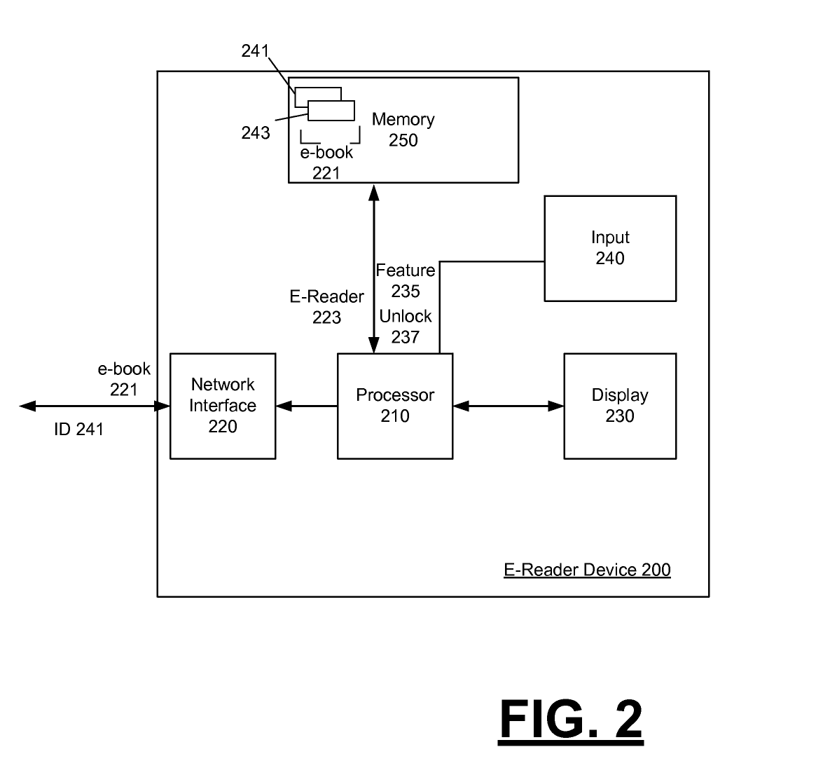

FIG. 2 illustrates an example of an e-reader device or other electronic personal display device, for use with one or more embodiments described herein. In an example of FIG. 2, an e-reader device 200 can correspond to, for example, a device, such as also shown by an example of FIG. 1. With reference to FIG. 2, e-reader device 200 includes a processor 210, a network interface 220, a display 230, one or more input mechanisms 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as e-books 221 or media files that the user elects to purchase or otherwise download from the network service 120. The application resources that are downloaded onto the e-reader device 200 can be stored in the memory 250. According to examples described herein, the e-books 221 can be provided as one or more files that include a locked portion 241 and an unlocked portion 243.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display which mimics conventional paper in the manner in which content is displayed. Examples of such display technologies include electrophoretic displays, electrowetting displays, and electrofluidic displays.

The processor 210 can receive input from various sources, including from input mechanisms 240 (e.g., buttons or switches, microphone, keyboard), the display 230 (e.g., soft buttons or keyboard) or other input mechanisms (accessory devices).

According to some embodiments, the memory 250 stores e-reader instructions 223 for rendering the e-book 221. The e-reader instructions 223 can be executed by the processor 210 to render the unlocked (or preview) portion of the e-book 221. Additionally, the e-reader instructions 223 can be executed by the processor 210 to render the locked portion 243 of the e-book 221 once the locked portion is unlocked.

The memory 250 can also store instructions for providing the preview and purchase feature (“feature instructions 235”), as well as instructions for implementing a mechanism to unlock the locked portion 243 of the e-book 221 (“unlock instructions 237”). The feature instructions 235 can be executed by the processor 210 in order to render a feature that enables the user to provide input to accept conditions provided with the e-book 221. The feature instructions 235 can be responsive to corresponding user input in order to trigger execution of the unlocked instructions 237. The unlock instructions 237 unlock the locked portion 243 of the e-book 221. In this way, the processor 210 can execute instructions to provide the preview and purchase feature 113 (see FIG. 1), and further to respond to a designated input provided through interaction with the feature in order to trigger implementation of the programmatic mechanism 115 (see FIG. 1). The result is that the user can view or otherwise consume the preview segment of the content item (e.g., e-book 221), and then seamlessly and without interruption, accept conditions for continuing to view or consume a remainder of the content item. In the context of e-books, the user can elect to purchase an e-book while reading the preview segment of the e-book. When a preview segment is complete, the user can continue to read the pages that sequentially follow the preview segment. In this way, the user reading experience is seamless and without disruption, as if the user had been reading the complete e-book from the beginning.

E-Reader System

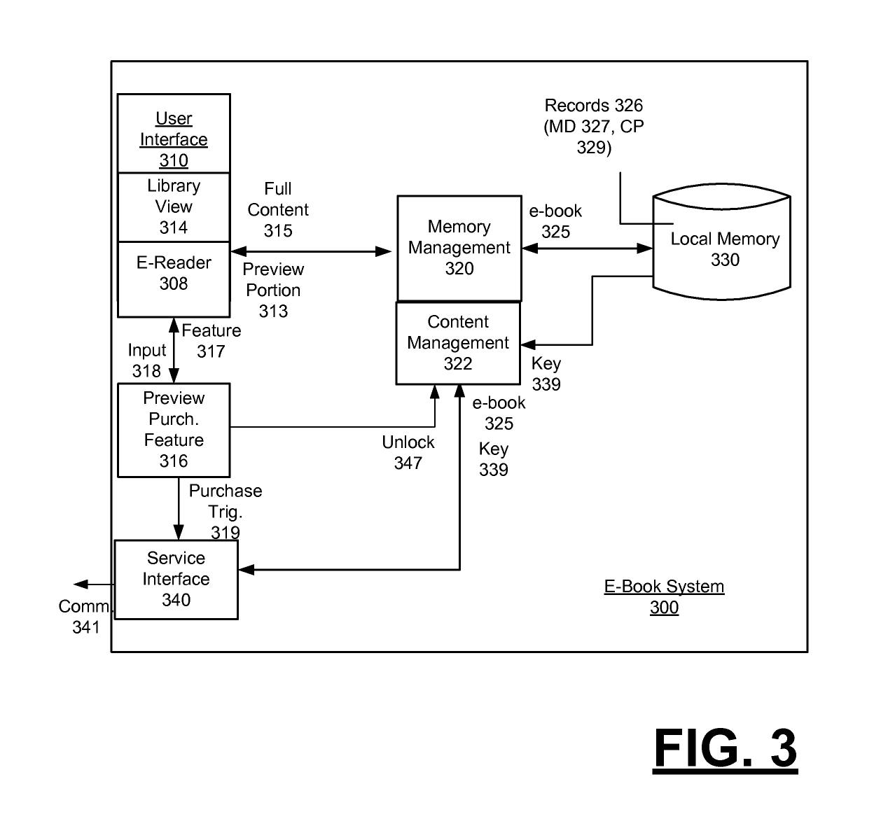

FIG. 3 illustrates an e-book device system for operating a computing device to render a content item from a preview, according to an embodiment. In reference to FIG. 3, a system 300 implements programmatic components for communicating with an e-book service (such as network service 120, shown in FIG. 1), as well as for enabling functionality for viewing and accessing e-books utilized by an account associated with the e-reader device 110 (see FIG. 1 or FIG. 2). In some embodiments, the system 300 can be implemented as an application that runs on an e-reader device, such as shown with examples of FIG. 1 or FIG. 2.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reader device 110. For example, the user can download an application onto the device that is operated as the e-reader device 110, in order to obtain functionality such as described with an example of FIG. 3. For example, the user can download an application onto an e-reader device, to obtain functionality such as described herein as well as to communicate with the network service 120. Alternatively, an application can be embedded or otherwise preinstalled with other programmatic elements for providing functionality such as described with system 300.

The service interface 340 includes application logic which enables the e-reader device 110 to use, for example, a wireless Internet connection to connect to the network service 120 (see FIG. 1). In connecting with the service, the service interface 340 can transmit data that enables the network service 120 to identify the e-reader device 110 on which system 300 is implemented, so that the network service 120 can determine the account that is associated with the particular e-reader device. The service interface 340 can be used to retrieve e-books 325 from the network service 120. For example, in identifying the e-reader device 110 of system 300 to the network service 120, the network service may be able to procure payment information (e.g., stored credit card information) that can be used to charge the users account when the user purchases a new e-book from the service. Each e-book can correspond to a literary work having a pagination format. Optionally, some e-books may have chapter designations, as well as content that corresponds to graphics or images (e.g., such as in the case of magazines or comic books). Individual e-books 325 can also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reader device of system 300, the network service 120 can identify what e-books belong to the account associated with the particular device. The e-books that are transmitted to the e-reader device of system 300 include those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reader device 110 to automatically receive their previously purchased e-book. Alternatively, as another example, network service 120 can be configured to push e-books to the e-reader device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reader device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The memory management module 320 can retrieve portions of individual e-books for purpose of rendering e-books via the user interface 310.

The user interface 310 includes an e-reader component 308 a library viewer 314 and a preview and purchase feature 316. The e-reader component 308 can perform operations to render portions of the e-book 325. The portions of the rendered e-book can include paginated content. The e-reader component 308 can also enable user input to transition paginated content, either sequentially, by clusters and/or by chapters.

The library viewer 314 displays metadata corresponding to e-books that are part of the user's library. The displayed metadata can correspond to listing an e-book title and author, as well as jacket art for individual e-books. The e-books that are in the user library can include those that are locally stored on the device of system 300. Additionally, in a variation, the e-books that are in the user library can include those that are archived with network service 120 and accessible for download by the user without additional payment or satisfaction of conditions.

The preview and purchase feature 316 can provide an input feature 317 with the e-reader component 308. In one implementation, the e-book 325 that is received from network service 120 corresponds to an e-book that the user has yet to purchase. The e-book 325 can be communicated with its content portions including a preview segment (unlocked portion) and a locked portion. Both portions may be provided to the device of system 300 at the same time. When the user wishes to view the e-book 325, the e-reader component 308 can use the memory management module 320 to retrieve the preview segment of the e-book 325.

The memory management module 320 can manage the storage the e-book 325 in the local memory 330. The memory management module 320 can access and provide the preview segment 313 for the e-reader component 308 when the locked portion of the e-book is locked. When the preview segment 313 is rendered through the e-reader component 308, the preview and purchase feature 316 can generate and display, or otherwise provide, to the user a feature 317 for prompting user input to purchase the e-book for which the preview segment 313 is being provided. The feature 317 can be provided with content that specifies the condition(s) for receiving the unlocked portion of the e-book. For example, the feature 317 can be provided as an icon that includes a purchase price.

The e-reader component 308 can receive input 318 from the user, signifying the intent of the user to purchase the e-book 325. In one implementation, the preview and purchase feature 316 is triggered by input 318 to communicate unlock signal 347 to the content management component 322 of the memory management module 320.

The memory management module 320 can include or provide content management component 322 to ensure the user only views the contents of the e-book that the user is permitted to view. The content management component 322 can include instructions (e.g., programmatic mechanism 115) for unlocking, or otherwise enabling rendering of the locked portion of the e-book 325. The content management component 322 can be responsive to the unlock signal 347, which is communicated in response to user input 318. In practicality, the user can provide input the 318 to indicate the user's acceptance of payment for that e-book 325. Absent payment, the user can only view the preview segment. But when the user provides input 318 that is responsive to feature 317, the preview and purchase feature 316 can provide the unlock signal 347 that causes the e-book 325 to be unlocked.

According to one aspect, content management component 322 can enforce a policy relating to the use of, for example, a shared key with the network service for unlocking the locked content. In one implementation, the network service 120 communicates an unlocking key 339 with the e-book 325, and the unlocking key 339 is stored in encrypted or protected form in the local memory 330 using a private key. The content management component 322 can respond to the unlock signal 347 by accessing the shared key (e.g., using the private key) and unlocking the locked portion of the e-book 325. In this way, the content management component 322 implements an enforcement policy that precludes access to the locked portion of the e-book that is in use. Initially, the content management component 322 permits, or otherwise enables access only to the unlocked portion of the e-book 325, which corresponds to the preview segment. The e-reader component 308 can then access the locked portion of the e-book in order to view the full content 315.

The preview and purchase feature 316 can also signal or purchase trigger 319 to the network service 120, via the service interface 340. The purchase trigger 319 identifies the e-book 325 that the user has elected the purchase. The service interface 340 can signal the communication 341 indicating the e-book 325 that the user has elected to purchase, as well as an identifier of the user or user account.

Methodology

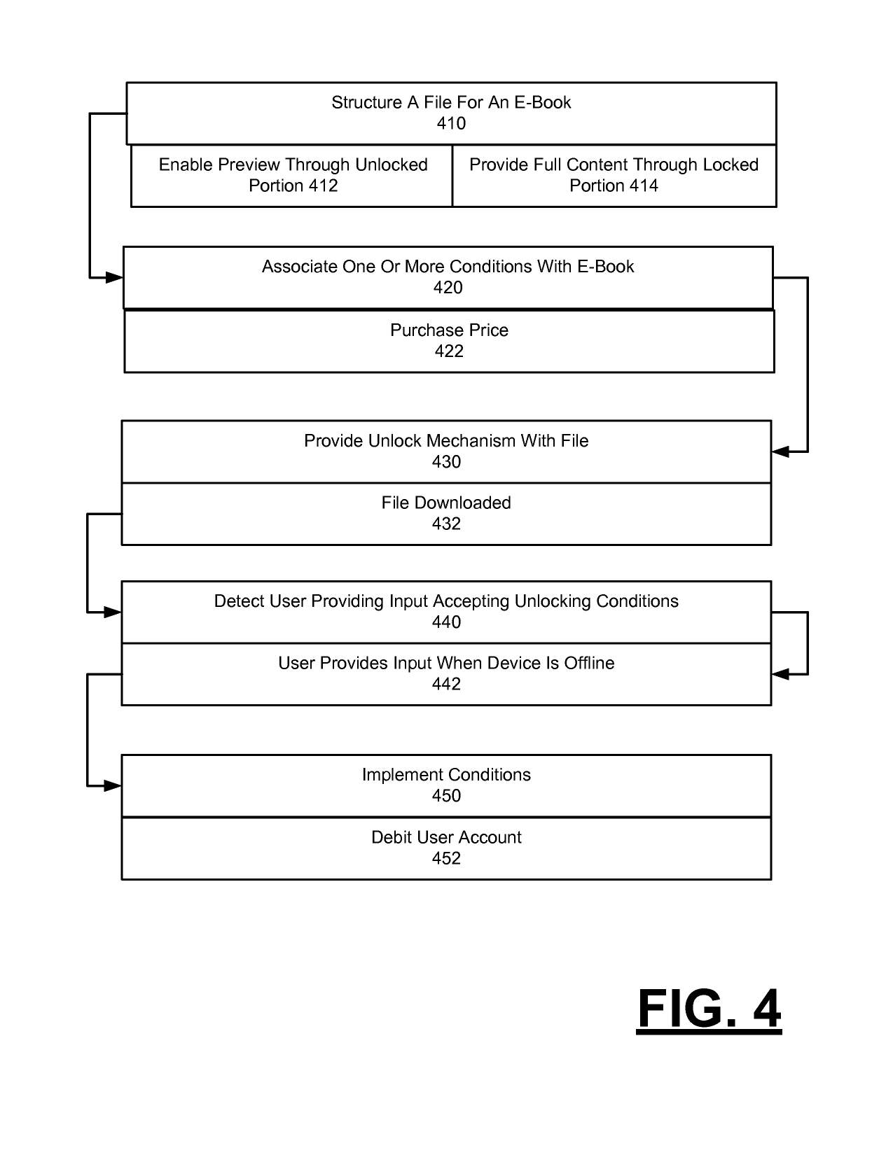

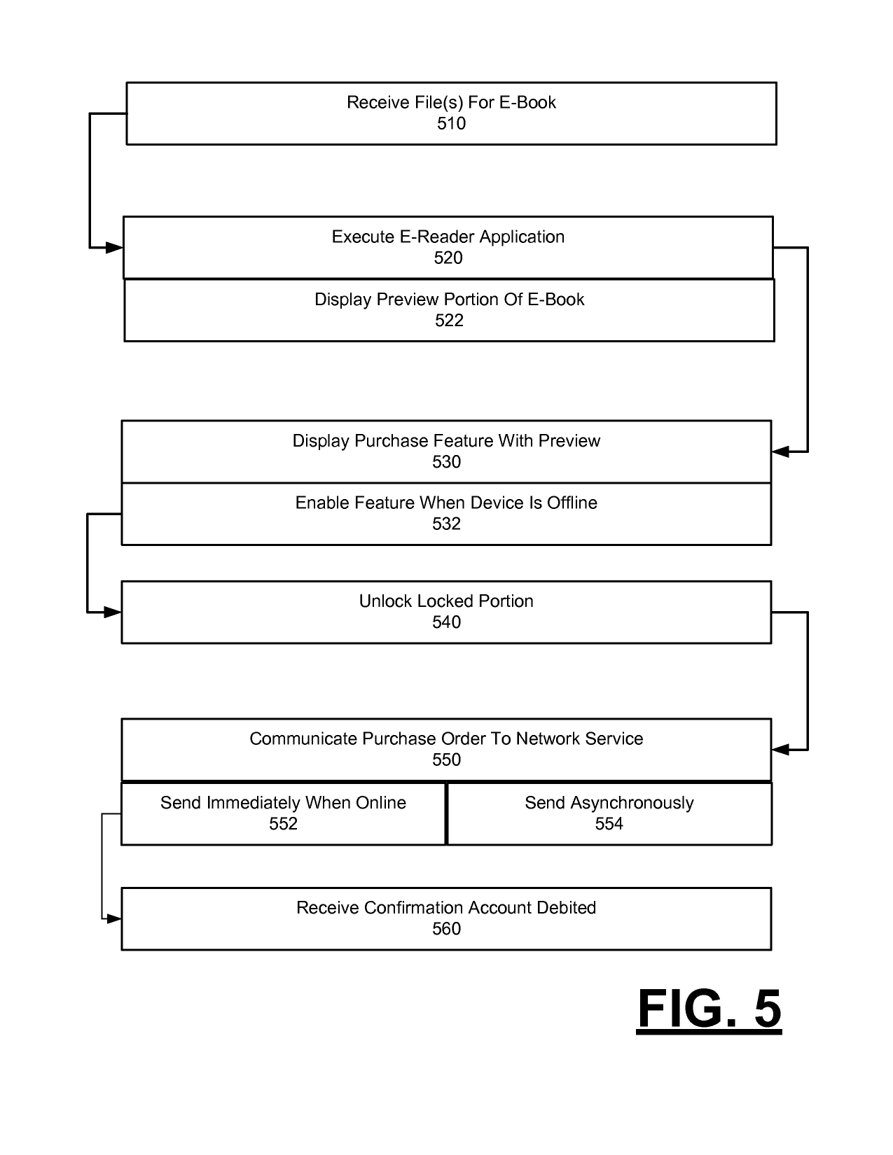

FIG. 4 illustrates an example method for operating a network service to provide a content item with a preview segment. FIG. 5 illustrates an example method for operating a computing device to render a preview segment of an e-book, and further to enable purchase of the e-book while the preview segment is rendered. Examples of methods such as described with FIG. 4 and FIG. 5 can be implemented using, for example, a system such as described with an example of FIG. 1, an e-reader device such as described with an example of FIG. 2, and/or an e-reader system such as described with an example of FIG. 3. Accordingly, reference may be made to elements of other figures for purpose of illustrating a suitable component for performing a step or sub step being described.

With reference to an example of FIG. 4, network service 120 can structure a file, or set of files, for selectively rendering a given content item on a computing device (e.g., e-reader device 110) (410). In particular, the file(s) of the e-book can be structured to include an unlocked or accessible portion, and a locked or inaccessible portion. The unlocked portion can correspond to a preview segment (412). The unlocked portion can provide a remainder or an entire content of the e-book (414). The portions of the e-book can be packaged together as one or more files so as to be transmitted from the network service 120 to, for example, the e-reader device 110 at one time.

In addition to structuring the file(s) of the e-book, the network service associates one or more conditions with the e-book (420). The conditions correspond to what the user agrees to in order to unlock the remainder or locked portion of the e-book. According to one implementation, the conditions can include the user's acceptance of a purchase price for the e-book in its entirety (422). For example, the network service 120 can provide the unlocked or preview segment for free at the same time as providing the locked portion of the e-book. In order to access the locked portion, the user can provide payment for the e-book via the network service 120. As variations, the conditions that the user may be required to accept in order to unlock the locked portion of the e-book can include, for example, an agreement to provide another form of compensation (e.g., trade in right to possession of another e-book); an agreement to enroll into a service provided by network service 120; and/or an agreement to provide a review or otherwise publicize the e-book.

The network service 120 may further structure the locked portion of the e-book to be unlockable by way of a corresponding programmatic mechanism on the e-reader device 110 (430). By way of example, the network service 120 and the e-reader device 110 can share a key for unlocking an encrypted file corresponding to the locked portion of the e-book. The e-reader component 114 can be implemented as a shared computing platform with the network service 120, and further include functionality that triggers use of the unlocking key in response to the occurrence of certain events, particularly to the user accepting one or more conditions associated with the e-book.

The structured portions of the files that comprise a particular e-book can then be transmitted to the e-reader device 110 of the given user (432). For example, the e-reader device 110 can download one or more files corresponding to a given e-book using a wireless network, such as a wireless fidelity (WiFi) network or cellular network.

The network service 120 can subsequently detect the user of the e-reader device 110 providing an input that indicates the user's acceptance of the one or more conditions for unlocking the downloaded e-book (440). For example, as described with an example of FIG. 5, the e-reader component of the user device can provide a feature for enabling the user to accept conditions (such as payment of purchase price) while viewing the preview segment of a e-book. The user input is communicated to the network service 120, and in response, the network service 120 implements the one or more conditions that are associated with the e-book. For example, the network service 120 can debit funds from the account 125 associated with the e-reader device 110, in accordance with the purchase price associated with the e-book.

In one implementation, the network service 120 detects the user input asynchronously with the e-book being unlocked on the e-reader device (442). For example, the e-reader device 110 can be off-line, or not connected to network service 120. In such instances, the e-reader device 110 can be programmed to store the user input, and to communicate input when connectivity is reestablished with the network service 120. In the meantime, the e-reader device 110 can independently unlock the locked portion of the e-book, using, for example, the shared key with the network service 120.

When the input is detected, the network service 120 can implement the conditions associated with the e-book (450). In this way, the implementation of the conditions can occur after the user has received access to the locked portion of the e-book. For example, the condition can correspond to the use acceptance of the purchase price for the e-book. The user can provide input that indicates the user's acceptance of the purchase price when the device is off-line. The e-book can be unlocked immediately in response to the user's input, without further instructions or communication from the network service 120. However, when network connectivity is reestablished with the network service 120, the user's acceptance of the conditions associated with the e-book are communicated to the network service 120 for implementation. In turn, the conditions associated with the e-book or implemented by the network service 120. If the condition corresponds to user acceptance of the purchase price, funds are debited from the user's account 125 (452). For example, the funds can be transferred according to the payment structure used by the network service 120.

With reference to FIG. 5, an e-reader device can receive one or more files for a given e-book (510). For example, the user can browse an online e-book store to select a particular e-book, or the user can subscribe to receive previews for multiple e-book's on a periodic basis. Rather than provide immediate payment for an e-book that the user may or may not enjoy, the user may elect to preview the particular e-book. In response to electing to preview the e-book, a set of files for the given e-book are transferred to the user's e-reader device. The file(s) can include data for rendering the content of the e-book in its entirety. However, as described with an example of FIG. 4, the communicated files can include a locked portion and an unlocked portion. The locked portion precludes the user from accessing any portion of the content of the e-book other than the preview. The preview segment, on the other hand, is readily accessible to the user on the e-reader device 110.

On the e-reader device, an e-reader application can execute to communicate with the network service 120 and to render content from e-books stored on the user device (520). When the files of the e-book being previewed or received, the preview segment of the e-book can be rendered through the e-reader application (522).

When the preview segment is rendered, the e-reader application can also display a purchase feature (530). In this way the purchase feature can be displayed with the preview content of the e-book. By way of example, the purchase feature can correspond to an icon that the user can select in order to purchase the e-book. The purchase feature (e.g., icon) can display content that indicates the condition(s) (e.g., purchase or download price) the user must accept in order to receive the locked portion of the e-book. The purchase feature can be persistent with the preview content, or selectable to appear. As also described, the purchase feature can prompt for user input when the e-reader device is either online or offline. The purchase feature can also be present with the preview content when the device is online or offline (532).

In response to the user providing the input, the locked portion of the e-book is unlocked (540). In some examples, the e-book is unlocked asynchronously, or independently of the network service 120 implement the conditions for unlocking the e-book. The e-reader device 110 can include resources for unlocking the locked e-book, without further data or instructions from the network service. For example, as described with an implementation of FIG. 3, the content management component 322 can implement a policy for use of a shared key that unlocks the locked content. In this way, when the device is off-line, the user input can be communicated to the network service 120 after the e-book is unlocked on the user device.

When the user input for unlocking the e-book is received, the e-reader device 110 communicates the input to the network service (550). In turn, the network service 120 can implement the one or more conditions associated with the e-book (e.g., debiting the user's account of funds corresponding to the purchase price of the e-book). In one implementation, when the e-reader device is online, the user input can be signaled immediately to the network service 120 (552). However, according to some aspects, the e-reader device 110 can send the communication asynchronously with unlocking the e-book (554). For example, when the e-reader device is off-line, the e-reader device 110 can store the user input and communicate the user input automatically to the network service 120 when network connectivity is reestablished.

In response to communicating the input, the e-reader device 110 can receive confirmation from the network service 120 (560). The confirmation can, for example, confirm implementation of conditions, such as the user account being debited.

### Examples

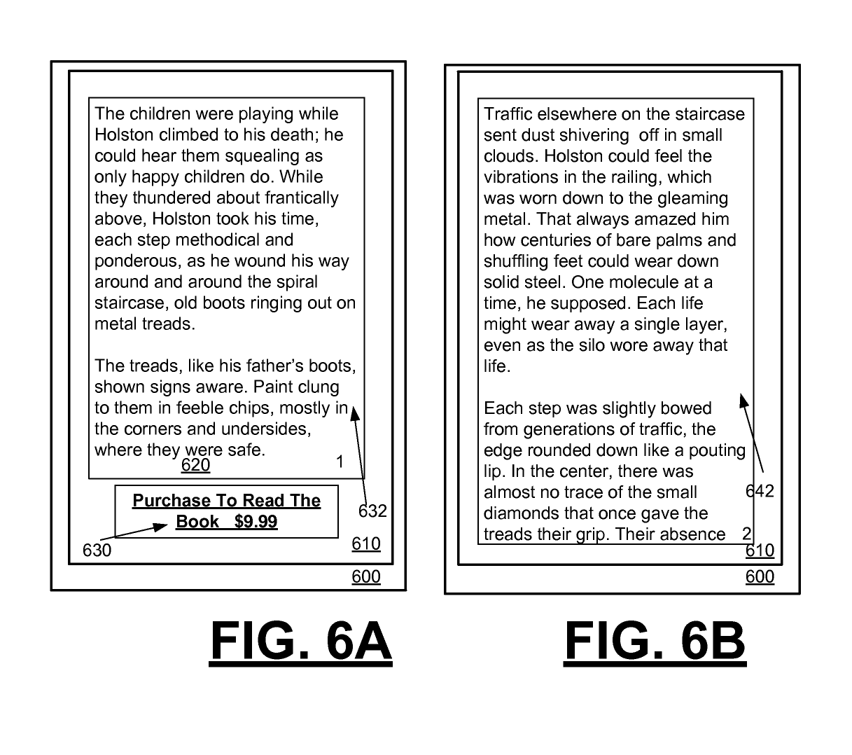

FIG. 6A and FIG. 6B illustrate an example in which an e-book is purchased while being previewed. An example of FIG. 6A and FIG. 6B illustrate the transition of an e-reader device from rendering a preview segment to rendering follow-on content (e.g., next page), so as to provide a seamless and continuous reading experience for the user. An example such as shown with FIG. 6A and FIG. 6B can be implemented using, for example, a system such as shown with an example of FIG. 1; an e-reader device such as shown with an example of FIG. 2; or a system such as shown with an example of FIG. 3. Accordingly, reference may be made to elements of other figures for purpose of illustrating a suitable component for implementing an example of FIG. 6A and FIG. 6B.

In FIG. 6A, an e-reader device 600 includes a display screen 610 on which preview content 620 is provided. The e-reader device 600 can download a corresponding e-book from, for example, network service 120. As described with various other examples, the download e-book can be provided with an unlocked preview segment 632, and a locked portion for the complete or fuller portion of the e-book. The e-reader 600 can include feature 630 for enabling the user to provide input to purchase the e-book.

The user can, for example, tap an icon associated with the feature 630. The icon can include content that indicates the condition for viewing or owning the locked portion, such as purchase price. Once tapped, the e-reader device 600 can signal an identifier of the account, as well as the e-book that was selected by the user input, to the network service 120. At the same time, the e-reader device 600 can unlock the locked portion of the corresponding e-book.

FIG. 6B illustrates content displayed on the e-reader device in response to the user input selecting to purchase the e-book. In the example provided, content 642 from the locked portion of the e-book is seamlessly displayed to the user. In this way, the user can purchase or otherwise satisfy conditions for receiving the locked portion of the e-book, without having to navigate away from the reading experience. Rather, the user can view the preview segment of the e-book (e.g., page 1), then select to purchase the e-book while viewing the preview segment. Upon providing the input, of the e-book is available to the user, as shown with an example of FIG. 6B.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for providing content, the method being implemented by one or more processors and comprising:
(a) providing one or more files that correspond to a content item to a computing device, the one or more files including a locked portion and an unlocked portion, the unlocked portion being renderable to provide a preview of the content item on the computing device;
(b) associating one or more conditions with the content item for unlocking the locked portion of the one or more files;
(c) enabling a programmatic mechanism to the computing device in order to allow a user of the computing device to provide input that accepts the one or more conditions and also unlocks the locked portion of the one or more files;
(d) detecting the user providing the input; and
(e) implementing the one or more conditions in response to detecting that the user provided the input.

2. The method of claim 1, wherein the one or more conditions include a payment term, and wherein implementing the one or more conditions includes debiting an account of the user for funds in accordance with the payment term.

3. The method of claim 1, wherein (a) through (e) are performed on a server that communicates with the computing device, and (c) includes detecting input the user previously provided on the computing device when the computing device was offline.

4. The method of claim 3, wherein (c) includes communicating the programmatic mechanism to the computing device, so that the computing device can implement the programmatic mechanism when the computing device is either online or offline.

5. The method of claim 3, wherein (c) includes communicating the programmatic mechanism as a feature of an application that communicates with the server and also renders the content item, so that the user input enables the locked portion of the content item to be renderable while the unlocked portion is being rendered on the computing device.

6. The method of claim 1, wherein the content item corresponds to an e-book.

7. A method for rendering content on a computing device, the method being implemented by one or more processors of the computing device and comprising:
receiving one or more files that correspond to a content item from a network service, the one or more files including a locked portion and an unlocked portion;
executing an application to render the unlocked portion as a preview while the locked portion is locked;
when executing the application,
(i) providing a feature for receiving a designated input that indicates a user accepts one or more conditions associated with the content item; and
(ii) in response to receiving the designated input, unlocking the locked portion of the content item.

8. The method of claim 7, further comprising executing the application to display the content from the locked portion of the content item during a same application session as executing the unlocked portion of the content item to provide the preview.

9. The method of claim 7, further comprising:
linking the computing device to an account of the user maintained by the network service; and
communicating an identifier of the account and the user's acceptance of the one or more conditions to the network service in response to receiving the designated user input.

10. The method of claim 9, further comprising displaying a confirmation provided from the network service, the confirmation indicating an amount debited from an account of the user in accordance with the one or more conditions.

11. The method of claim 9, wherein providing the feature and unlocking the locked portion is performed during a duration in which the computing device has no network connectivity.

12. The method of claim 9, further comprising displaying the locked portion during a same application session as executing the unlocked portion of the content item to provide the preview, and wherein displaying the locked portion is performed prior to communicating the identifier of the account and the user's acceptance of the one or more conditions to the network service.

13. The method of claim 7, wherein providing the feature includes displaying one or more conditions for unlocking the locked portion of the content item on the computing device.

14. The method of claim 7, wherein the content item corresponds to an e-book, and wherein the application corresponds to an e-reader.

15. A computing device comprising:
a memory that stores a set of instructions;
one or more processors that access the set of instructions in order to perform operations that comprise:
receiving one or more files that correspond to a content item from a network service, the one or more files including a locked portion and an unlocked portion;
executing an application to render the unlocked portion as a preview while the locked portion is locked;
when executing the application,
(i) providing a feature for receiving a designated input that indicates a user accepts one or more conditions associated with the content item; and
(ii) in response to receiving the designated input, unlocking the locked portion of the content item.

16. The computing device of claim 15, wherein the one or more processors access the instructions in order to perform operations that comprise:
executing the application to display the content from the locked portion of the content item during a same application session as executing the unlocked portion of the content item to provide the preview.

17. The computing device of claim 15, wherein the one or more processors access the instructions in order to perform operations that comprise:
linking the computing device to an account of the user maintained by the network service; and
communicating an identifier of the account and the user's acceptance of the one or more conditions to the network service in response to receiving the designated user input.

18. The computing device of claim 17, wherein the one or more processors access the instructions in order to perform operations that comprise:
displaying a confirmation provided from the network service, the confirmation indicating an amount debited from an account of the user in accordance with the one or more conditions.

19. The computing device of claim 17, wherein providing the feature and unlocking the locked portion is performed during a duration in which the computing device has no network connectivity.

20. The computing device of claim 17, wherein the one or more processors access the instructions in order to perform operations that comprise:
displaying the locked portion during a same application session as executing the unlocked portion of the content item to provide the preview, and wherein displaying the locked portion is performed prior to communicating the identifier of the account and the user's acceptance of the one or more conditions to the network service.
